(19) United States
(12) Patent Application Publication
(10) Pub. No.: US 2014/0052950 A1
(43) Pub. Date: Feb. 20, 2014

(54) SYSTEM CONTROLLING APPARATUS, INFORMATION PROCESSING SYSTEM, AND CONTROLLING METHOD OF SYSTEM CONTROLLING APPARATUS

(71) Applicant: FUJITSU LIMITED, Kawasaki-shi (JP)

(72) Inventor: Yoshihito Matsushita, Kawasaki (JP)

(21) Appl. No.: 13/916,630

(22) Filed: Jun. 13, 2013

(30) Foreign Application Priority Data
Aug. 14, 2012 (JP) 2012-179905

(51) Int. Cl. G06F 12/14

(52) U.S. Cl. CPC G06F 12/14
USPC 711/163

(57) ABSTRACT

A system controlling apparatus that controls an information processing apparatus, includes: an issuing unit that, in accessing a component provided in the information processing apparatus, issues to the component an access request including address information specifying an address in a register provided in the component and count information indicating a number of times to access the component by the access; and an executing unit that accesses the component when a response indicating that the component permits the access request is received from the information processing apparatus.

### CROSS-REFERENCE TO RELATED APPLICATION

This application is based upon and claims the benefit of priority from Japanese Patent Application No. 2012-179905, filed on Aug. 14, 2012, the entire contents of which are incorporated herein by reference.

### FIELD

The embodiment discussed herein is related to a system controlling apparatus, an information processing system, and a controlling method of the system controlling apparatus.

### BACKGROUND

There is a large-scale computer system, like a high performance computing (HPC) model, in which a plurality of system boards (hereinafter referred to as “SB”) are mounted on a rack and the like. An installation area of the computer system is reduced by mounting a large number of components in high density on each SB.

For example, each SB is provided with a plurality of components such as a power source controlling device, a storage device, an arithmetic device, and a communication device. These components are controlled for a system operation and for a debug use by a system controlling apparatus (a service processor, which is hereinafter referred to as “SP”) provided in the computer system.

A control of components by an SP according to related techniques will be explained with reference to FIG. 8. FIG. 8 is a block diagram of an example of a configuration of an SP and an SB according to related techniques. As illustrated in FIG. 8, a computer system 900 is provided with an SP 910 and an SB 920. The SP 910 is provided with a software executing unit 911 for controlling components. The SB 920 is provided with an inter-integrated circuit controlling circuit 921 (the trademark of the inter-integrated circuit is registered as “I2C”, and expression “I2C” will be used in the explanation below), a power source controlling device 922, an arithmetic device 923, a storage device 924, and a communication device 925. The power source controlling device 922, the arithmetic device 923, the storage device 924, and the communication device 925 are collectively referred to as “component(s)” when they are not discriminated from each other.

The I2C controlling circuit 921 is provided with an indirect access register 921a and respective components include I2C controlling circuits 922b to 925b and internal registers 922a to 925a. The SP 910 and the SB 920 are connected by an I2C bus 901. In the SB 920, the I2C controlling circuit 921 and the components are connected by an I2C bus 902.

The software executing unit 911 of the SP 910 transmits a controlling command to the I2C controlling circuit 921 in executing a control of the components of the SB 920. The I2C controlling circuit 921 then sets the command received from the software executing unit 911 in the indirect access register 921a to control the components.

For example, when receiving a request for writing data in an address “0x0000_{—}0008” of the internal register 923a provided in the arithmetic device 923 from the software executing unit 911, the I2C controlling circuit 921 executes a process below. Specifically, the I2C controlling circuit 921 writes the address “0x0000_{—}0008” of the internal register 923a in an address register of the indirect access register 921a via I2C access. The address written in the indirect access register 921a is then written by the I2C controlling circuit 923b provided in the arithmetic device 923 in the internal register 923a after being written in an indirect access register 923c provided in the I2C controlling circuit 923b.

When receiving a response to the effect that the writing is completed from the I2C controlling circuit 923b provided in the arithmetic device 923, the I2C controlling circuit 921 writes data received from the software executing unit 911 in a data register [63:32] of the indirect access register 921a via I2C access. The I2C controlling circuit 921 then writes the data received from the software executing unit 911 in a data register [31:0] of the indirect access register 921a via I2C access.

As a result, values for the data register [63:32] and the data register [31:0] are written in the address “0x0000_{—}0008” of the internal register 923a provided in the arithmetic device 923. The arithmetic device 923 then responds with a result obtained by the writing of the data in the address “0x0000_{—}0008” of the internal register 923a to the SP 910. More detailed information of the related techniques can be obtained in Japanese Laid-Open Patent Publication No. 6-309219 and Japanese Laid-Open Patent Publication No. 5-134918.

However, there is a case of having a collision of I2C accesses at a time of performing debug in the above-explained related techniques.

There is a case where the I2C access is performed multiple times in reading from or writing in an internal register of each component. Besides, in an initial debug of hardware, a script for directly performing reading from or writing in the indirect access register 921a of the I2C controlling circuit 921 is used in addition to the software for controlling components.

There is therefore a case where an access by the software for controlling components and an access by the script have a collision and an abnormal failure in reading from or writing in an internal register of a component is caused.

Here, a case where the software executing unit 911 for controlling components that writes data in the address “0x0000_{—}0008” of the internal register 923a and a script for writing data in an address “0x0000_{—}0010” of the internal register 923a have a collision will be taken as an example.

The software executing unit 911 writes the address “0x0000_{—}0008” of the internal register 923a in the address register of the indirect access register 921a via I2C access. The script then writes the address “0x0000_{—}0010” of the internal register 923a in the address register of the indirect access register 921a via I2C access. When the software executing unit 911 writes values which are wanted to be written in the data register [63:32] and the data register [31:0] of the indirect access register 921a via I2C access, values of the data registers are written in the address “0x0000_{—}0010” of the internal register. In this case, malfunction occurs in the SB 920. In addition, there is a case where scripts for debug have a collision in performing debug in parallel with respect to a plurality of blocks in a component.
Patent Document 1: Japanese Laid-Open Patent Publication No. 6-309219
Patent Document 2: Japanese Laid-Open Patent Publication No. 5-134918

### SUMMARY

According to an aspect of an embodiment of the invention, a system controlling apparatus that controls an information processing apparatus, includes: an issuing unit that, in accessing a component provided in the information processing apparatus, issues to the component an access request including address information specifying an address in a register provided in the component and count information indicating a number of times to access the component by the access; and an executing unit that accesses the component when a response indicating that the component permits the access request is received from the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration of a computer system according to an embodiment;

FIG. 2 illustrates an example of a configuration of a component;

FIG. 3 is a functional block diagram illustrating a functional configuration of a processor realized by using a component driver in an SP;

FIG. 4 is a flowchart of a procedure of a reading process by the processor realized by using the component driver;

FIG. 5 is a flowchart of a procedure of a writing process by the processor realized by using the component driver;

FIG. 6 is a flowchart of a procedure of a process by a processor realized by an I2C driver;

FIG. 7 is a flowchart of a procedure of a process by an I2C controlling circuit; and

FIG. 8 is a block diagram illustrating an example of a configuration of an SP and SB according to related techniques.

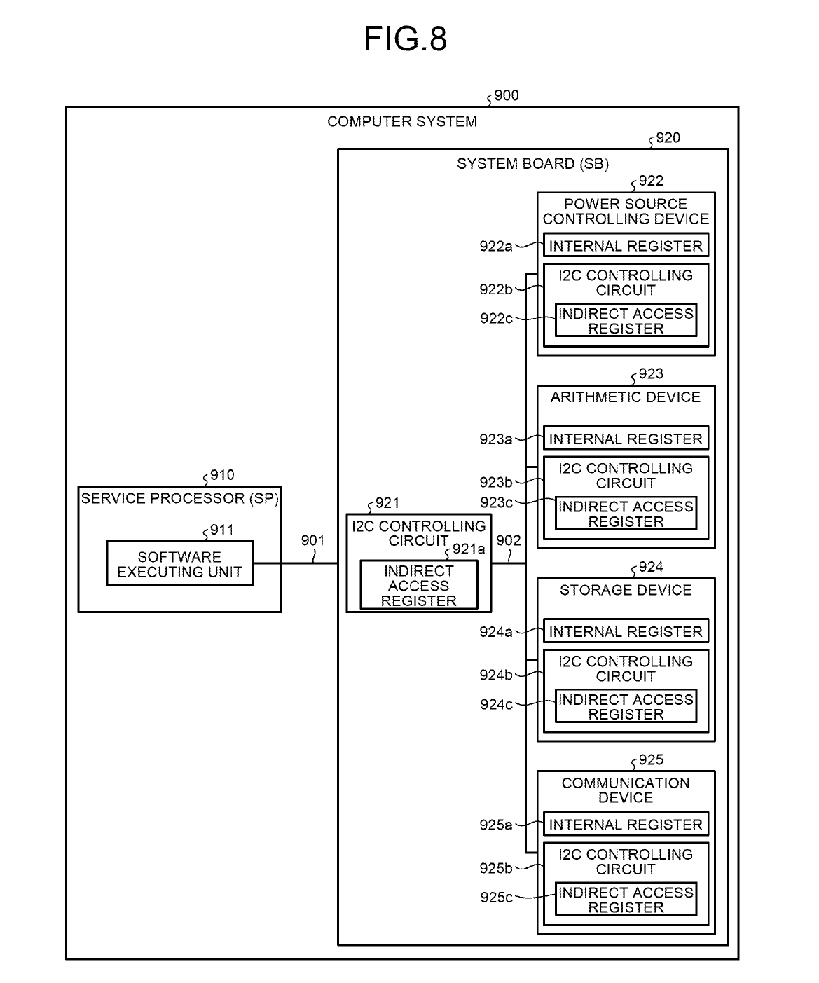

### DESCRIPTION OF EMBODIMENTS

A preferred embodiment of a system controlling apparatus, an information processing system, a controlling method of the system controlling apparatus, and a program for controlling the system controlling apparatus according to the invention will be explained in detail below with reference to the accompanying drawings. It should be noted that the present invention is not limited to the embodiment. The embodiment may be arbitrarily combined within a scope which does not cause a contradiction in processing contents.

### [a] Embodiment

In an embodiment, a computer system is taken as an example of an information processing system. The computer system is provided with a service processor that functions as a system controlling apparatus and a system board that functions as an information processing apparatus.

Configuration Of Computer System According To Embodiment

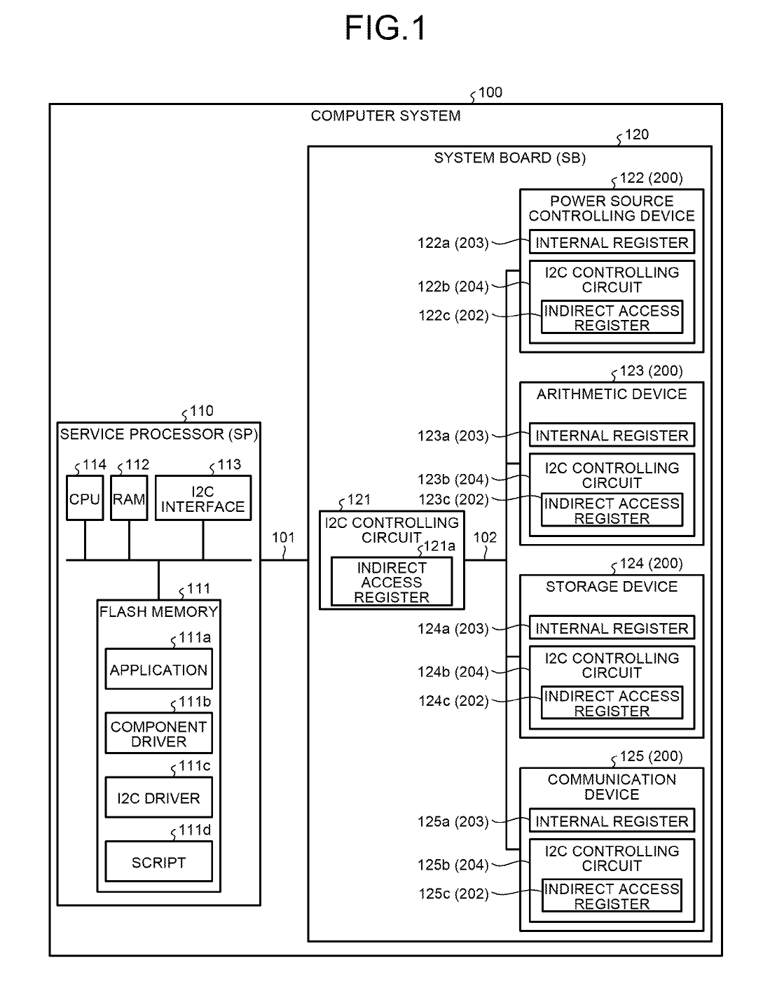

A configuration of a computer system 100 according to an embodiment will be explained with reference to FIG. 1. FIG. 1 illustrates an example of a configuration of the computer system 100 according to the embodiment. As illustrated in FIG. 1, the computer system 100 according to the embodiment is provided with a service processor (hereinafter referred to as “SP”) 110 and a system board (hereinafter referred to as “SB”) 120.

Besides, the SP 110 and the SB 120 are connected via an I2C bus (the trademark of the Inter-Integrated Circuit is registered as “I2C” which will be used in the explanation below) 101 in the computer system 100 as illustrated in FIG. 1. Here, the connection between the SP 110 and the SB 120 is not limited to the I2C bus. The SP 110 and the SB 120 may be connected via any of other buses such as the Serial Peripheral Interface® (SPI), the Microwire®, and the Joint Test Architecture Group (JTAG) specified by the IEEE 1149. 1.

Configuration Of SB According To Embodiment

Next, a configuration of the SB according to the embodiment will be explained. As illustrated in FIG. 1, the SB 120 is provided with an I2C controlling circuit 121, a power source controlling device 122, an arithmetic device 123, a storage device 124, and a communication device 125. Here, when not being discriminated, the power source controlling device 122, the arithmetic device 123, the storage device 124, and the communication device 125 are referred to as “component(s) 200”. In the SB 120, the I2C controlling circuit 121 and each of the components 200 are connected via an I2C bus 102.

Here, the power source controlling device 122 controls a power source of the SB 120. The arithmetic device 123 executes various arithmetic processes in the SB 120. The storage device 124 stores data and programs used in the SB 120. The communication device 125 controls transmission and reception of information between the SB 120 and other devices.

Each of the components 200 is provided with an internal register 203 and an I2C controlling circuit 204. For example, the power source controlling device 122 is provided with an internal register 122a and an I2C controlling circuit 122b and the arithmetic device 123 is provided with an internal register 123a and an I2C controlling circuit 123b. The storage device 124 is provided with an internal register 124a and an I2C controlling circuit 124b and the communication device 125 is provided with an internal register 125a and an I2C controlling circuit 125b.

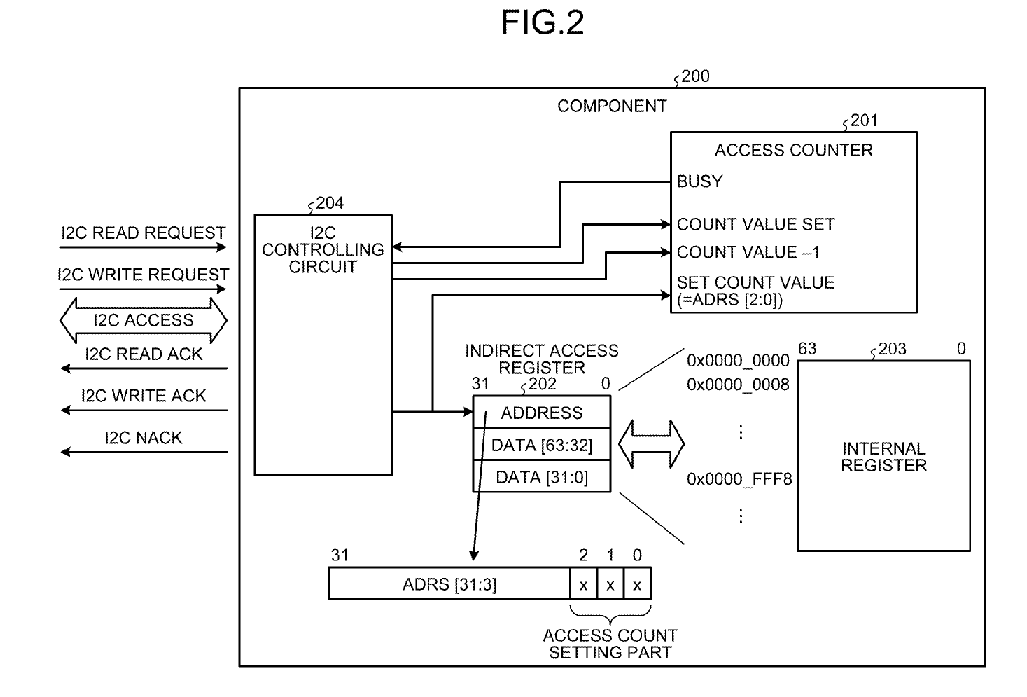

The internal register 203 stores setting values of various kinds and data by making them associated with addresses. The I2C controlling circuit 204 is provided with an indirect access register 202 and controls reading and writing of data between the internal register 203 and the I2C controlling circuit 121. A detail of the internal register 203, the I2C controlling circuit 204, and the indirect access register 202 will be explained later with reference to FIG. 2.

The I2C controlling circuit 121 is provided with an indirect access register 121a and controls reading and writing of data between the SP 110 and each of the components 200 via the indirect access register 121a. The indirect access register 121a is provided with an address register storing area (hereinafter referred to as “address register”) and a data register storing area (hereinafter referred to as “data register”).

For example, when receiving an access request from the SP 110, the I2C controlling circuit 121 makes an inquiry about whether to permit an access to the I2C controlling circuit 204 provided in the requested component 200. When the access is permitted, the I2C controlling circuit 121 writes an address of the internal register 203 provided in the component 200 to which the access is requested in the address register of the indirect access register 121a.

When the access request is a read request, data retained in the address of the internal register 203 provided in the component 200 is written in the data register of the indirect access register 121a via the I2C controlling circuit 204 provided in the component 200. The I2C controlling circuit 121 responds with a value written in the data register in response to the read request from the SP 110.

When the access request is a write request, the I2C controlling circuit 121 receives requested data from the SP 110. The I2C controlling circuit 121 then writes the data received from the SP 110 in the data register of the indirect access register 121a. As a result of this, the data the writing of which is requested from the SP 110 is written in the internal register 203 provided in the component 200.

Here, the I2C controlling circuit 121, the power source controlling device 122, the arithmetic device 123, the storage device 124, and the communication device 125 form an Application Specific Integrated Circuit (ASIC), a Field Programmable Gate Array (FPGA), and any integrated circuits of other kinds.

Configuration Of SP According To Embodiment

Next, a configuration of the SP according to the embodiment will be explained. As illustrated in FIG. 1, the SP 110 is provided with a flash memory 111, a Random Access Memory (RAM) 112, an I2C interface 113, and a Central Processing Unit (CPU) 114.

The flash memory 111 stores an application 111a, a component driver 111b, an I2C driver 111c, and a script 111d. The application 111a is a program that causes an execution of operation processes of various kinds. The application 111a is executed in cooperation with the RAM 112 and the CPU 114.

The component driver 111b is a program for controlling an access to a requested component when an access request to the component is received according to the application 111a. The component driver 111b is executed in cooperation with the RAM 112 and the CPU 114. The component driver 111b thus realizes a processor 300.

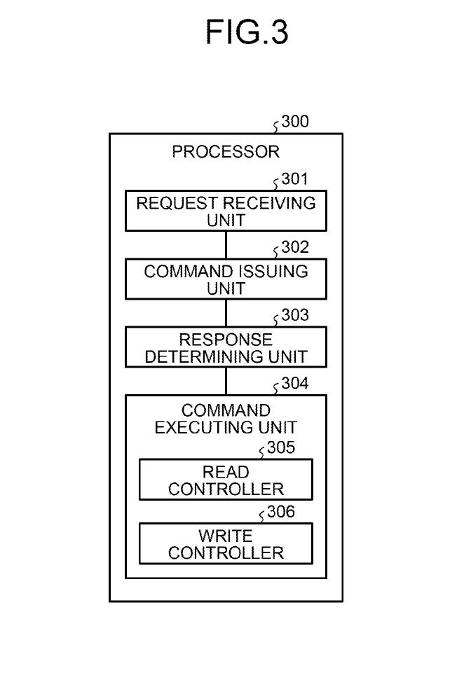

When issuing an access request to the component 200 provided in the SB 120 to control, the processor 300 executes the following process, for example. Specifically, the processor 300 issues an access request to the component 200 by including information specifying an address in the internal register 203 provided in the component 200 and information indicating the number of times to access the component 200 in the access request. The processor 300 accesses the component 200 when receiving a response indicating that the access request to the component 200 is permitted from the SB 120. A detailed configuration of the processor 300 realized by the component driver 111b will be explained later with reference to FIG. 3.

The I2C driver 111c is a program for controlling an I2C access between the SP 110 and the SB 120. The I2C driver 111c is executed in cooperation with the RAM 112 and the CPU 114. The I2C driver 111c thus realizes a processor 400.

When receiving a command from the component driver 111b, the processor 400 executes an access to the indirect access register 121a, for example. When the response from the I2C controlling circuit 204 is “ACK”, the processor 400 responds with “ACK” to the component driver 111b. On the other hand, when the response from the I2C controlling circuit 204 is “NACK”, the processor 400 responds with “NACK” to the component driver 111b.

The script 111d is a program for controlling the I2C driver 111c independently from the application 111a and the component driver 111b in debugging. The script 111d is executed in cooperation with the RAM 112 and the CPU 114. The script 111d thus realizes a processor 500.

When accessing a component provided in the SB 120 to control, the processor 500 executes the following process, for example. Specifically, the processor 500 issues an access request to the component 200 by including information specifying an address in the internal register 203 provided in the component 200 and information indicating the number of times to access the component 200 in the access. The processor 500 accesses the component 200 when receiving a response indicating that the access request to the component 200 is permitted from the SB 120.

The RAM 112 stores the application 111a, the component driver 111b, the I2C driver 111c, and the script 111d read out by the CPU 114 from the flash memory 111.

The I2C interface 113 transmits an I2C command to the SB 120. The I2C interface 113 receives an I2C command from the SB 120. The CPU 114 executes arithmetic processes of various kinds and also executes the application 111a, the component driver 111b, the I2C driver 111c, and the script 111d stored in the flash memory 111.

Configuration Of Component 200

Next, a configuration of the component 200 will be explained with reference to FIG. 2. FIG. 2 illustrates an example of a configuration of the component 200. As illustrated in FIG. 2, the component 200 is provided with an access counter 201, the indirect access register 202, the internal register 203, and the I2C controlling circuit 204.

The internal register 203 stores setting values and data of various kinds by making them associated with addresses. As illustrated in FIG. 2, the internal register 203 stores 64-bit data for each address.

The access counter 201 retains the number of times corresponding to count information included in the access request by the SP 110 to which the access request is permitted. In other words, the access counter 201 retains the number of times by which the SP 110 to which the access request is permitted executes an access in the access request. The access count retained by the access counter 201 is subtracted each time when the SP 110 executes an access.

The indirect access register 202 is provided with the address register, the data register [64:32], and the data register [31:0]. In the address register, an address of the internal register 203 of the component 200 to which an access is requested from the SP 110 is stored. Here, lower three bits of the access register are used as an access count setting part.

In the data register [63:32], values from the 63rd bit to the 32nd bit of data to be written in the address of the internal register 203 to which an access is requested or of data read out from the address of the internal register 203 to which an access is requested are stored. In the data register [31:0], values from the 31st bit to the 0th bit of the data to be written in the address of the internal register 203 to which an access is requested or of the data read out from the address of the internal register 203 to which an access is requested are stored.

The I2C controlling circuit 204 receives one of the I2C read request and the I2C write request from the SP 110 by way of the I2C controlling circuit 121 and responds to the received one of the read request and the write request.

For example, when receiving an access request from the SP 110, the I2C controlling circuit 204 determines whether or not the number of times retained in the access counter 201 indicates that an access other than the received access request is not in the middle of execution. More specifically, the I2C controlling circuit 204 determines whether or not the value retained in the access counter 201 represents information indicating that an access other than the currently requested access is not in the middle of execution. For example, the I2C controlling circuit 204 determines whether or not the value retained in the access counter 201 is “0”. The I2C controlling circuit 204 determines that an access other than the currently requested access is not in the middle of execution when the value retained in the access counter 201 is “0”. On the other hand, the I2C controlling circuit 204 determines that an access other than the currently requested access is in the middle of execution when the value retained in the access counter 201 is not The I2C controlling circuit 204 then makes a response to the effect that the access request is permitted or not permitted based on a result of the determination. When determining that an access other than the currently requested access is not in the middle of execution, the I2C controlling circuit 204 responds with “ACK” which indicates that the access request is permitted and causes the access counter 201 to retain the access count included in the access request.

In addition, the I2C controlling circuit 204 sets an address in the indirect access register 202. Here, when the access request is a read request, data retained in the set address of the internal register 203 is stored in the indirect access register 202. The I2C controlling circuit 204 then responds with the data stored in the indirect access register 202 to the SP 110 when the read access is executed.

The I2C controlling circuit 204 receives data from the SP 110 and stores the received data in the indirect access register 202 when the access request is a write request and the write access is executed. The data stored in the indirect access register 202 is thus written in the internal register 203.

The I2C controlling circuit 204 subtracts the number of times retained in the access counter 201 each time when an access is performed from the SP 110. In other words, the I2C controlling circuit 204 subtracts the number of times retained in the access counter 201 whenever a read access or a write access is executed by the SP 110.

The I2C controlling circuit 204 responds with “NACK” which indicates that the access request is not permitted when determining that an access other than the currently requested access is in the middle of execution.

Functional Configuration Of Processor 300 Realized By Component Driver 111b

Next, a functional configuration of the processor realized by using the component driver 111b in the SP 110 according to the embodiment will be explained with reference to FIG. 3. FIG. 3 is a functional block diagram illustrating a functional configuration of the processor realized by using the component driver 111b in the SP 110. Here, the component driver 111b executed in the SB 110 is realized in cooperation with the RAM 112 and the CPU 114.

As illustrated in FIG. 3, the processor 300 realized by the component driver 111b is provided with a request receiving unit 301, a command issuing unit 302, a response determining unit 303, and a command executing unit 304.

The request receiving unit 301 receives, from the application 111a, a read request which is a request for reading data from the internal register 203 of the component 200 or a write request which is a request for writing data in the internal register 203 of the component 200. The request receiving unit 301 then requests the command issuing unit 302 to issue an access request.

The command issuing unit 302 executes the following process when accessing the component 200 provided in the SB 120. Specifically, the command issuing unit 302 issues, to the component 200, an access request including address information specifying an address in the register provided in the component 200 and count information indicating the number of times to access the component 200 in the access.

For example, the command issuing unit 302 includes information indicating whether the access is a read access or a write access in a command. The command issuing unit 302 uses a part of information specifying an address for information indicating the number of times. As one example, the command issuing unit 302 uses lower two bits or three bits of the information specifying the address to specify information indicating the number of access times. Here, an example of using lower three bits to specify information indicating the number of access times will be explained.

The response determining unit 303 determines whether the response received from the I2C driver 111c is “ACK” or “NACK”. The response determining unit 303 requests the command executing unit 304 to execute an access when determining that the response received from the I2C driver 111c is “ACK”.

The response determining unit 303 requests the command issuing unit 302 to reissue an access request when determining that the response received from the I2C driver 111c is “NACK”. As a result of this, the command issuing unit 302 reissues an access request including address information and count information.

The command executing unit 304 is provided with a read controller 305 and a write controller 306, and accesses the component 200 when receiving, from the SB 120, a response indicating that the component 200 permits the access request.

The read controller 305 requests the I2C driver 111c to execute a read access to read out data from the internal register 203 of the component 200 when receiving a read request from the application 111a. The read controller 305 then responds to the application 111a with the read data.

The write controller 306 receives data to write when receiving a write request from the application 111a. The write controller 306 then requests the I2C driver 111c for a write access of the received data.

Procedure Of Process By Processor 300 Realized By Component Driver 111b

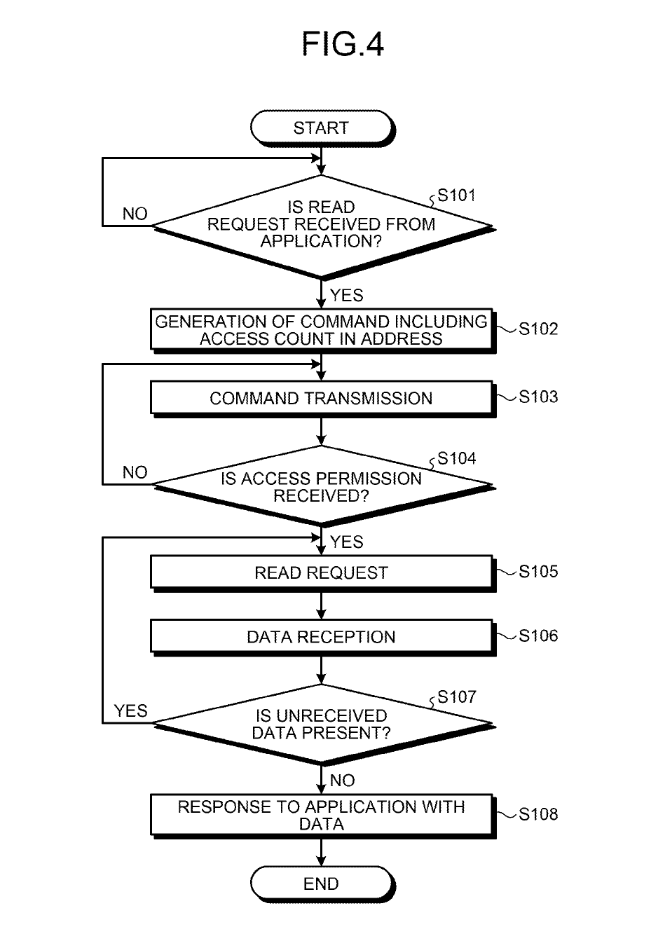

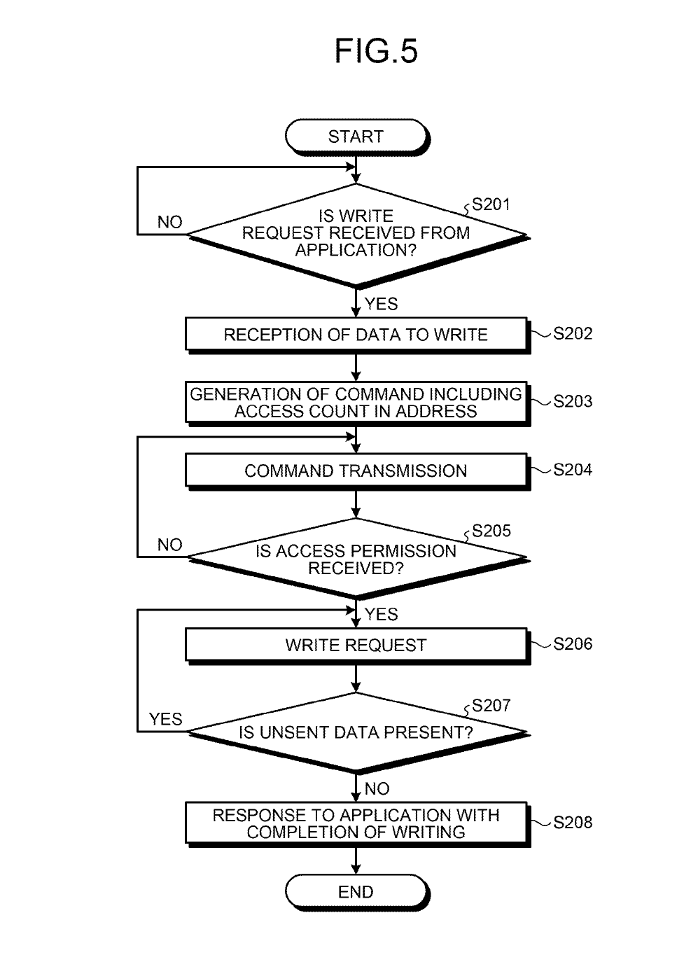

Next, a procedure of a process by the processor 300 realized by the component driver 111b will be explained with reference to FIGS. 4 and 5. Here, a reading process will be explained with reference to FIG. 4 and a writing process will be explained with reference to FIG. 5.

Reading Process

FIG. 4 is a flowchart of a procedure of a reading process by the processor 300 realized by the component driver 111b. As illustrated in FIG. 4, the request receiving unit 301 determines whether or not a read request which is a request for reading out data from the internal register 203 of the component 200 is received from the application 111a (step S101). When the request receiving unit 301 determines that a read request is received form the application 111a (“Yes” at step S101), the command issuing unit 302 generates an access request command including an access count in an address (step S102).

The command issuing unit 302 then transmits the generated access request command (step S103). The response determining unit 303 then determines whether or not an access permission is received (step S104). Here, the command issuing unit 302 moves to step S103 and transmits the access request command when the response determining unit 303 determines that the access permission is not received (“No” at step S104).

The read controller 305 executes, on the I2C driver 111c, the read request for reading out data from the internal register 203 of the component 200 (step S105) when the response determining unit 303 determines that the access permission is received (“Yes” at step S104). The read controller 305 then receives data read out from the internal register of the component 200 from the I2C driver 111c (step S106).

The read controller 305 then determines whether or not unreceived data of the data requested is present (step S107). Here, the read controller 305 moves to step S105 and receives data read out from the internal register 203 of the component 200 from the I2C driver 111c when determining that unreceived data of the data requested is present (“Yes” at step S107).

The read controller 305 responds to the application 111a with the data read out from the internal register 203 of the component 200 (step S108) and ends the reading process when determining that unreceived data of the data request is not present (“No” at step S107).

When determining that a read request is not received from the application 111a (“No” at step S101), the request receiving unit 301 continuously determines whether or not a read request is received from the application 111a.

Writing Process

FIG. 5 is a flowchart of a procedure of a writing process by the processor 300 realized by the component driver 111b. As illustrated in FIG. 5, the request receiving unit 301 determines whether or not a write request which is a request for writing data in the internal register 203 of the component 200 is received from the application 111a (step S201). The request receiving unit 301 receives data to write from the application 111a (step S202) when determining that a write request is received from the application 111a (“Yes” at step S201).

The command issuing unit 302 then generates an access request command including an access count in an address (step S203).

The command issuing unit 302 then transmits the generated access request command (step S204). The response determining unit 303 then determines whether or not an access permission is received (step S205). Here, the command issuing unit 302 moves to step S204 and transmits an access request command when the response determining unit 303 determines that the access permission is not received (“No” at step S205).

When the response determining unit 303 determines that the access permission is received (“Yes” at step S205), the write controller 306 executes, on the I2C driver 111c, a write request for writing data to write in the internal register 203 of the component 200 (step S206).

The write controller 306 then determines whether or not unsent data of the data that is requested to write is present (step S207). Here, the write controller 306 moves to step S206 and executes, on the I2C driver 111c, a write request for writing data to write in the internal register 203 of the component 200 when determining that unsent data of the requested data is present (“Yes” at step S207).

The write controller 306 responds, to the application 111a, with a completion of the writing of the data to write (step S208) and ends the writing process when determining that unsent data of the requested data is not present (“No” at step S207).

Here, the request receiving unit 301 continuously determines whether or not a write request is received from the application 111a when determining that a write request is not received from the application 111a (“No” at step S201).

Procedure Of Process By Processor 400 Realized By I2C driver 111c

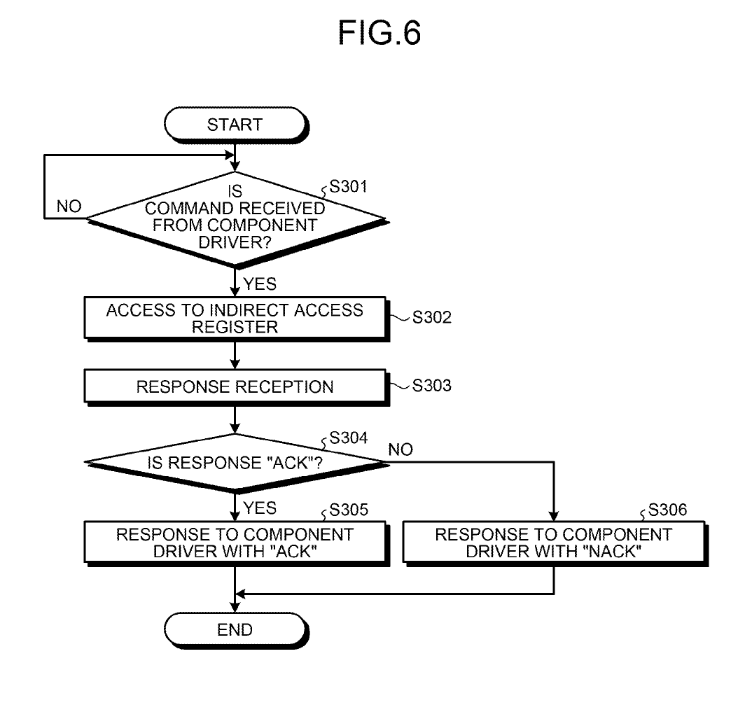

A procedure of a process performed by the processor 400 realized by the I2C driver 111c will be explained next with reference to FIG. 6. FIG. 6 is a flowchart of a procedure of a process by the processor 400 realized by the I2C driver 111c.

The processor 400 determines whether or not a command is received from the component driver 111b (step S301). Here, the processor 400 executes an access to the indirect access register 121a (step S302) when determining that a command is received from the component driver 111b (“Yes” at step S301).

The processor 400 then receives a response from the I2C controlling circuit 204 (step S303). The processor 400 then determines whether or not the response received from the I2C controlling circuit 204 is “ACK” (step S304). Here, when determining that the response received from the I2C controlling circuit 204 is “ACK” (“Yes” at step S304), the processor 400 responds, to the component driver 111b, with “ACK” (step S305) and ends the process.

On the other hand, when determining that the response received from the I2C controlling circuit 204 is not “ACK” (“No” at step S304), the processor 400 responds, to the component driver 111b, with “NACK” (step S306) and ends the process.

Procedure Of Process By I2C Controlling Circuit 204

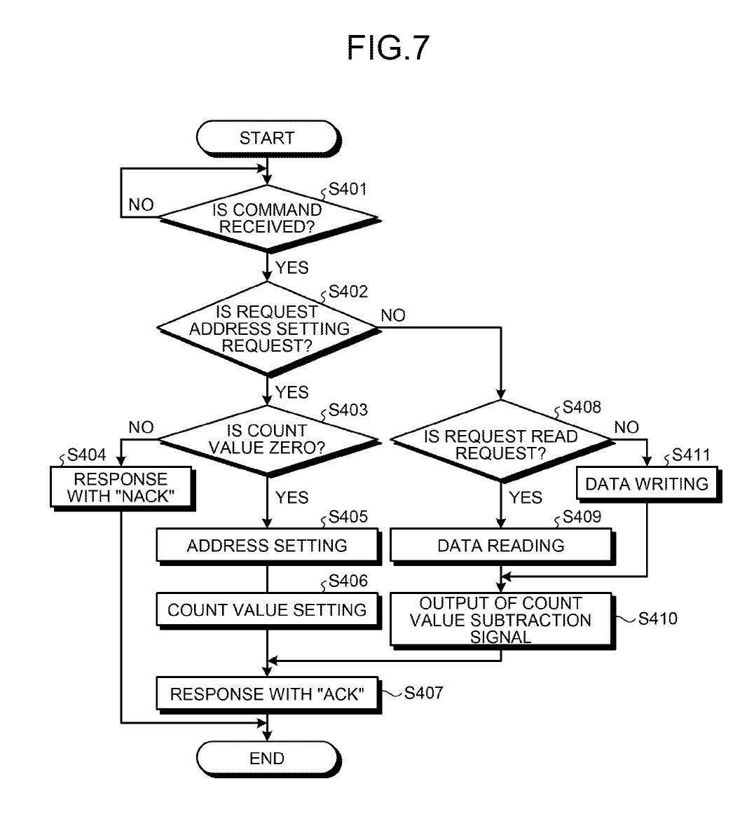

A procedure of a process performed by the I2C controlling circuit 204 will be explained next with reference to FIG. 7. FIG. 7 is a flowchart of a procedure of a process by the I2C controlling circuit 204.

As illustrated in FIG. 7, the I2C controlling circuit 204 determines whether or not a command is received from the I2C driver 111c (step S401). Here, the I2C controlling circuit 204 determines whether or not the received command is an address setting request (step S402) when determining that a command is received from the I2C driver 111c (“Yes” at step S401).

The I2C controlling circuit 204 determines whether or not a count value of the access counter 201 is zero (step S403) when determining that the received command is an address setting request (“Yes” at step S402). For example, the I2C controlling circuit 204 inputs a count value setting signal to the access counter 201.

The I2C controlling circuit 204 then responds, to the I2C driver 111c, with “NACK” (step S404) when determining that the count value of the access counter 201 is not zero (“No” at step S403).

Besides, the I2C controlling circuit 204 sets an address in the indirect access register 202 (step S405) when determining that the count value of the access counter 201 is zero (“Yes” at step S403). The I2C controlling circuit 204 then sets a count value in the access counter 201 (step S406) and responds, to the I2C driver 111c, with “ACK” (step S407).

The I2C controlling circuit 204 determines whether or not the received command is a read request (step S408) when determining that the received command is not an address setting request (“No” at step S402). The I2C controlling circuit 204 reads out data (step S409) when determining that the received command is a read request (“Yes” at step S408). The I2C controlling circuit 204 then inputs a count value subtraction signal to the access counter 201 (step S410). The I2C controlling circuit 204 executes step S407 after ending the process at step S410.

The I2C controlling circuit 204 writes data (step S411) when determining that the received command is not a read request (“No” at step S408). The I2C controlling circuit 204 executes step S410 after ending the process at step S411. The I2C controlling circuit 204 ends the process after ending the process at step S404 or the process at 5407.

### Advantages Of Embodiment

As explained so far, it is possible in the system controlling apparatus according to the embodiment to prevent an I2C access collision in debug. More specifically, it is possible in the SP 110 according to the embodiment to prevent a collision in a plurality of I2C accesses to the same component 200. For example, it is possible in the SP 110 according to the embodiment to realize an access between a script for an initial debug of hardware and a firmware for controlling system board without taking a collision into consideration.

All or a part of each process explained in the embodiment as being performed automatically can be performed manually. Besides, all or a part of each process explained as being performed manually can be performed automatically in a known method. Furthermore, a process procedure, a control procedure, and a specific name in the description and the drawings can be arbitrarily modified unless otherwise specified. Besides, the sequence of processes at steps of each process explained in the embodiment may be changed depending on loads of various kinds and a usage condition.

The illustrated constituents are only exemplary and explanatory on a functional and conceptual basis, and are not necessarily required to be configured physically as illustrated. For example, the request receiving unit 301 and the command issuing unit 302 may be integrated in the processor 300. Furthermore, all or a part of a processing function performed by each device may be realized by a CPU and a program to be analyzed and executed by the CPU or may be realized as a hardware by a wired logic.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A system controlling apparatus that controls an information processing apparatus, the system comprising:
an issuing unit that, in accessing a component provided in the information processing apparatus, issues to the component an access request including address information specifying an address in a register provided in the component and count information indicating a number of times to access the component by the access; and
an executing unit that accesses the component when a response indicating that the component permits the access request is received from the information processing apparatus.

2. The system controlling apparatus according to claim 1, wherein the issuing unit uses a part of the information specifying the address for information indicating the number of times.

3. The system controlling apparatus according to claim 1, wherein the issuing unit reissues the access request including the address information and the count information when a response indicating that the component does not permit the access request is received from the information processing apparatus.

4. An information processing system provided with an information processing apparatus and a system controlling apparatus that controls the information processing apparatus, wherein
the system controlling apparatus includes:
an issuing unit that, in accessing a component provided in the information processing apparatus, issues to the component an access request including address information specifying an address in a register provided in the component and count information indicating a number of times to access the component by the access; and
an executing unit that accesses the component when the system controlling apparatus receives a response indicating that the component permits the access request from the information processing apparatus and
the component provided in the information processing apparatus includes:
a counter that retains the number of times corresponding to the count information included, by the system controlling apparatus to which the access request is permitted, in the access request;
a subtracting unit that subtracts the number of times retained in the counter each time when accessed by the system controlling apparatus;
a determining unit that determines whether or not the number of times retained in the counter indicates that an access other than the received access request is not in a middle of execution when receiving the access request from the system controlling apparatus; and
a responding unit that makes one of a response to an effect of permitting the access request and a response to an effect of not permitting the access request based on a result of the determination by the determining unit.

5. A controlling method of a system controlling apparatus that controls an information processing apparatus, the controlling method comprising:
Issuing, by an issuing unit provided in the system controlling apparatus, when the issuing unit accesses a component provided in the information processing apparatus, to the component an access request including address information specifying an address in a register provided in the component and count information indicating a number of times to access the component by the access; and
accessing, by an executing unit provided in the system controlling apparatus, the component when the system controlling apparatus receives a response indicating that the component permits the access request from the information processing apparatus.

6. The controlling method according to claim 5, wherein the issuing includes using a part of the information specifying the address for information indicating the number of times.

7. The controlling method according to claim 5, wherein the issuing includes reissuing the access request including the address information and the count information when a response indicating that the component does not permit the access request is received from the information processing apparatus.

8. A computer-readable recording medium which stores therein a program for controlling a system controlling apparatus that controls an information processing apparatus, the program causing a computer to execute a process comprising:
issuing, when the issuing unit accesses a component provided in the information processing apparatus, to the component an access request including address information specifying an address in a register provided in the component and count information indicating a number of times to access the component by the access and
accessing the component when the system controlling apparatus receives a response indicating that the component permits the access request from the information processing apparatus.

9. The computer-readable recording medium according to claim 8, wherein the issuing includes using a part of the information specifying the address for information indicating the number of times.

10. The computer-readable recording medium according to claim 8, wherein the issuing includes reissuing the access request including the address information and the count information when a response indicating that the component does not permit the access request is received from the information processing apparatus.
